(19) United States
(12) Patent Application Publication
(10) Pub. No.: US 2015/0272014 A1
(43) Pub. Date: Oct. 1, 2015

(54) PORTABLE PLANTER AND SUPPORT

(71) Applicant: Melvin Byler, Middlefield, OH (US)

(72) Inventor: Melvin Byler, Middlefield, OH (US)

(21) Appl. No.: 14/668,346

(22) Filed: Mar. 25, 2015

Related U.S. Application Data
(60) Provisional application No. 61/970,095, filed on Mar. 25, 2014.

(51) Int. Cl. A01G 9/16

(52) U.S. Cl. CPC A01G 9/16

(57) ABSTRACT

A growing assembly including a greenhouse and support for the greenhouse, such as a stand or brackets, is disclosed. The greenhouse is capable of storing various items, such as plants, and can be easily and quickly placed on a stand or brackets. The stand has wheels, which make the stand and greenhouse supported by the stand quickly and easily portable. The brackets provide support for the greenhouse so that the greenhouse may be easily mounted on a wall and easily removed from the brackets when access to the greenhouse is desired.

### CROSS-REFERENCE TO RELATED APPLICATIONS

This application claims priority to U.S. Provisional Patent Application No. 61/970,095, filed on Mar. 25, 2014, the entirety of which is incorporated by reference herein.

### BACKGROUND

The present disclosure relates to a growing assembly including a greenhouse and a supporting device for the greenhouse, such as a stand or brackets. The stand has wheels, which make the stand and greenhouse supported by the stand quickly and easily portable. The brackets provide support for the greenhouse so that the greenhouse may be easily stored on the brackets and easily removed from the brackets when access to the greenhouse is necessary.

### BRIEF DESCRIPTION

Described in various embodiments herein is a growing assembly including a greenhouse and a supporting device for the greenhouse, such as a stand or brackets. Generally, the greenhouse is capable of holding various items, particularly plants. The greenhouse can be quickly and easily placed on a stand or brackets for supporting the greenhouse. The greenhouse can then be quickly and easily removed from the stand or brackets for adding, removing, or rearranging the contents of the greenhouse. The greenhouse is also capable of being worked in when the greenhouse is placed on a stand or brackets. The stand or brackets provide a convenient way to store the greenhouse when not in use.

The greenhouse is designed for holding various items and is generally large enough to house one or more plants. The stand is designed to hold the greenhouse and to be easily and quickly portable. The brackets are designed to be mounted onto a vertical surface (e.g. a wall) and hold the greenhouse. The greenhouse may also be accessed and used when placed on the stand or brackets. The greenhouse, stand, and brackets are all easy to use. The stand is easy to transport, and the greenhouse can be easily transported either by itself or when placed on the stand.

These and other embodiments are described in more detail below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front top perspective view of a greenhouse.

FIG. 2 is a perspective view of the bottom of a greenhouse.

FIG. 3 is a perspective view of a first embodiment of a rolling stand.

FIG. 4 is a perspective view of a growing assembly formed from a greenhouse and the rolling stand of FIG. 3.

FIG. 5 is a perspective view of a bracket.

FIG. 6 is a perspective view of a growing assembly formed from a greenhouse and two brackets of FIG. 5.

FIG. 7 is a perspective view of a second embodiment of a rolling stand.

FIG. 8 is a perspective view of a growing assembly formed from a greenhouse and the rolling stand of FIG. 7.

FIG. 9 is a front perspective view of a rolling stand of FIG. 7 with a first extension.

FIG. 10 is a rear perspective view of the stand of FIG. 9 with the first extension.

FIG. 11 is a front perspective view of a second extension mounted upon a first extension.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional acts or structures. However, such description should be construed as also describing the devices and parts as “consisting of” and “consisting essentially of” the enumerated components, and excluding other structures.

Numerical values should be understood to include numerical values which are the same when reduced to the same number of significant figures and numerical values which differ from the stated value by less than the experimental error of the conventional measurement technique used to determine the value.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

Some of the terms used herein are relative terms. For example, the terms “front” and “rear” are relative to a center, with the front being located opposite to the rear, as indicated by the use of the term “opposing.” The terms “inner” and “outer” are relative to a volume, with “inner” being inside or within the volume. However, the terms “top” and “bottom” and “upward” and “downward” are also relative to an absolute reference, i.e. the surface of the earth. Put another way, a top location is always located at a higher elevation than a bottom location and an element that extends “upward” always extends away from the surface of the earth, opposite an element that points “downward” toward the surface of the earth. As used herein, the front and rear are located along an x-axis, the left and right are located along a y-axis, and the top and bottom are located along a z-axis, wherein the three axes are perpendicular to each other.

The terms “plane” and “planar” are used herein to refer generally to a common level, and should be construed as referring to a volume, not as a flat surface.

The term “parallel” should be construed in its lay term as two edges or faces generally continuously having the same distance between them, and should not be strictly construed in mathematical terms as requiring that the two edges or faces cannot intersect when extended for an infinite distance. Similarly, the term “perpendicular” should not be construed as requiring that two faces meet at an angle of absolutely 90°.

The term “substantially”, as used herein refers to a variance of plus/minus 5% (±5%) when used in conjunction with a numerical value.

The present disclosure relates to a growing assembly including a greenhouse and a support for the greenhouse, such as a stand or brackets. Several different types of supports are described herein.

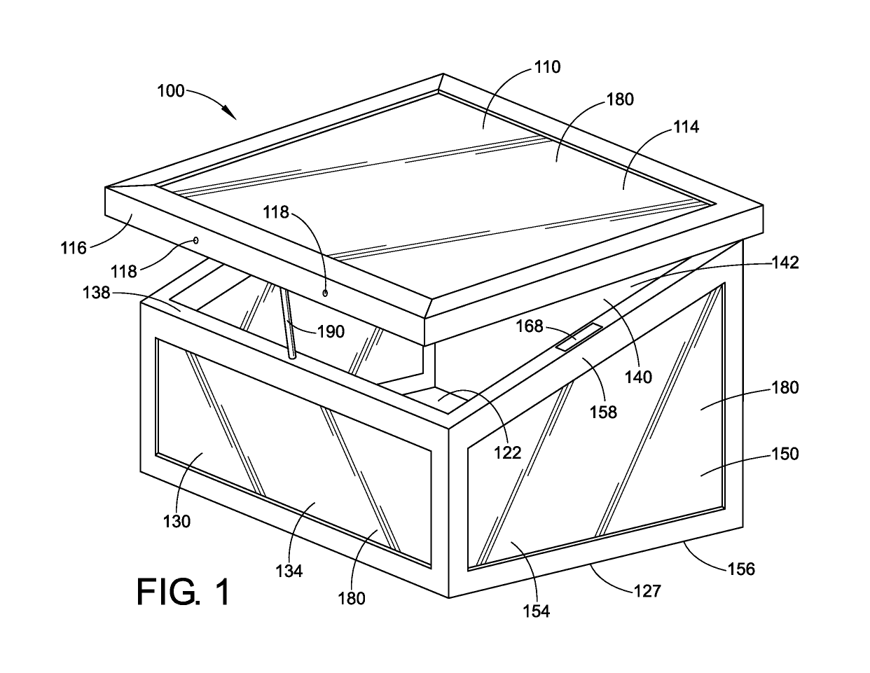

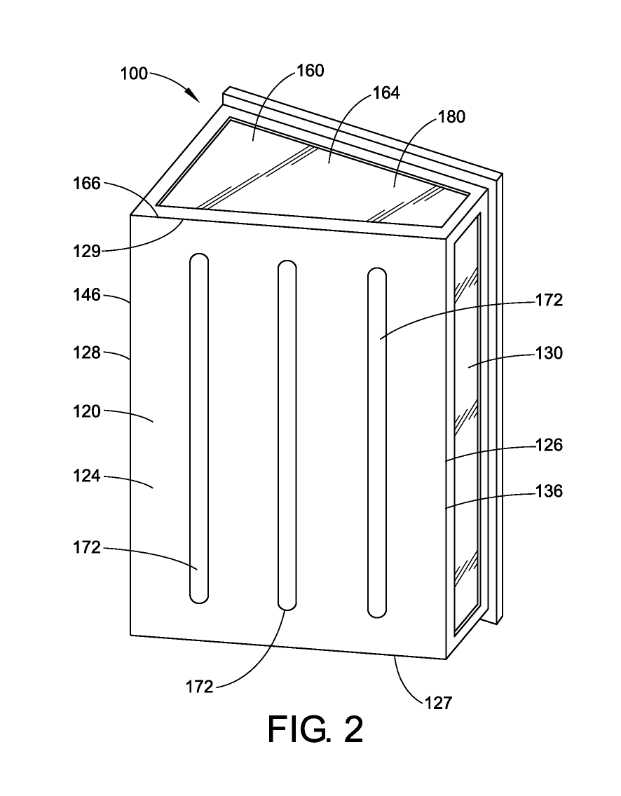

FIG. 1 is a top front perspective view of a greenhouse 100. FIG. 2 is a bottom perspective view of the greenhouse 100. The greenhouse 100 has a lid member 110, a bottom member 120, a front wall 130, a rear wall 140, a first sidewall 150, and a second sidewall 160.

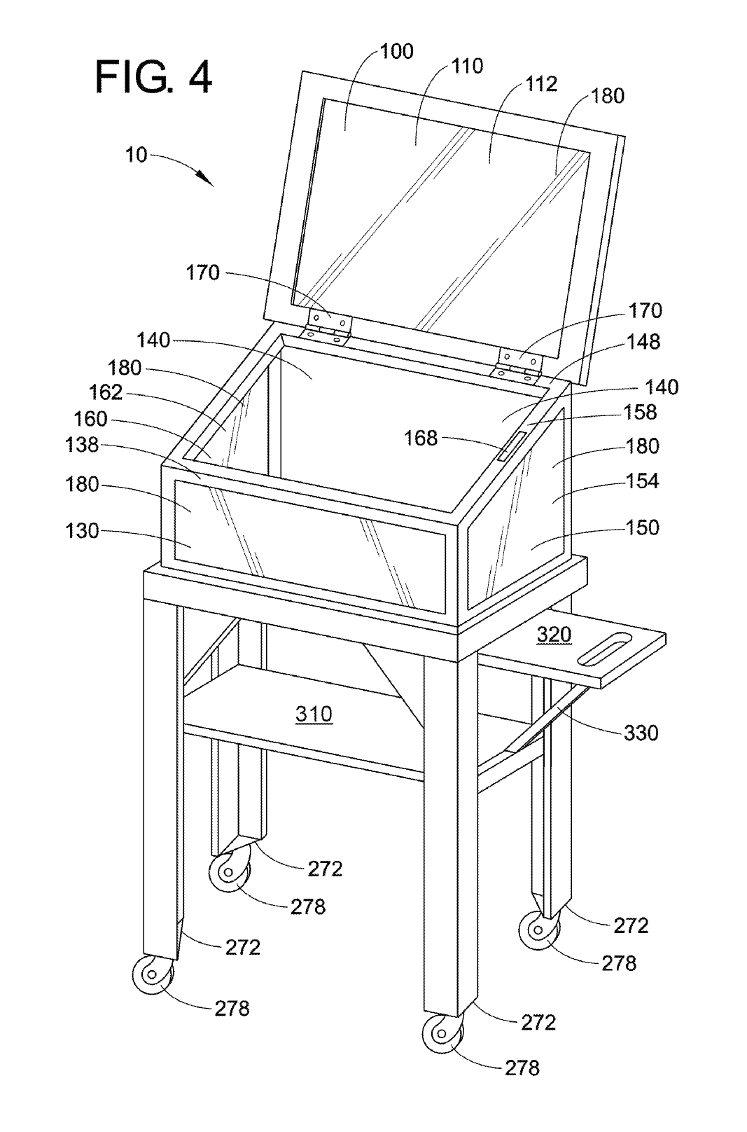

The lid member 110 has an inner face 112 and an outer face 114. The inner face 112 of lid member 110 can be best seen in FIG. 4 when the lid member 110 is in an opened position. The inner face 112 and the outer face 114 are substantially parallel to one another. The lid member 110 may include at least one hole 118, which helps to provide ventilation to the interior of the greenhouse 100. The hole 118 may be located in a forward edge 116 of lid member 110. Alternatively, the hole 118 may be located on the outer face 114 of lid member 110, passing completely through lid member 110 to the inner face 112 of lid member 110.

The bottom member 120 has an inner face 122 and an outer face 124. The outer face 124 of bottom member 120 can be best seen in FIG. 2. The inner face 122 and the outer face 124 are substantially parallel to one another.

The front wall 130 has an inner face (not visible) and an outer face 134. The inner face and the outer face 134 of front wall 130 are substantially parallel to one another. A lower edge 136 of front wall 130 connects to a front edge 126 of bottom member 120.

The rear wall 140 has an inner face 142 and an outer face (not visible). The inner face 142 and the outer face of rear wall 140 are substantially parallel to one another. The rear wall 140 is located opposite the front wall 130. The rear wall 140 and the front wall 130 are separated by the bottom member 120. A lower edge 146 of the rear wall 140 connects to a rear edge 128 of the bottom member 120. The rear wall 140 is also connected to the lid member 110 by at least one hinge 170. The wings of the hinge 170 are connected to a top edge 148 of rear wall 140 and the inner face 112 of lid member 110. In this way, lid member 110 is rotatable between an opened position and a closed position. The lid member 110 in the opened position can be best seen in FIG. 4.

The first sidewall 150 has an inner face (not shown) and an outer face 154. The inner face and the outer face 154 of first sidewall 150 are substantially parallel to one another. A bottom edge 156 of first sidewall 150 connects to a first side edge 127 of bottom member 120.

The second sidewall 160 has an inner face 162 (see FIG. 4) and an outer face 164. The inner face 162 and the outer face 164 of second sidewall 160 are substantially parallel to one another. A bottom edge 166 of second sidewall 160 connects to a second side edge 129 of bottom member 120.

As can be best seen in FIG. 1, greenhouse 100 includes at least one pin 190. Pin 190 is placed between a top edge 138 of front wall 130 and the inner face 112 of lid member 110. In this way, pin 190 can hold the lid member 110 in an opened position to help provide ventilation for greenhouse 100. When not in use, pin 190 can be easily stored in a groove 168 in a top edge 158 of one of the sidewalls 150, 160. Groove 168 is of a size sufficient to hold pin 190 therein.

When pin 190 is placed in the groove 168, the lid member 110 may be rotated to a closed position. In the closed position, the lid member 110 contacts the top edges 158 of the sidewalls 150, 160. The pin 190 is not necessary for holding the lid member 110 in the opened position. Rather, the lid member 110 may be rotated to a fully opened position while pin 190 remains in the groove 168, as can be best seen in FIG. 4. Pin 190 is particularly useful for holding the lid member 110 at a position between a fully closed position and a fully open position.

As shown in FIG. 1, the lid member 110, the bottom member 120, the front wall 130, the rear wall 140, the first sidewall 150, and the second sidewall 160 have transparent panel portions 180. The transparent panel portions 180 allow for light to pass from outside the greenhouse 100 to inside the greenhouse 100. Similarly, the transparent panel portions 180 allow a user to see inside the greenhouse 100 without opening lid member 110.

FIG. 2 is a perspective view of the bottom of greenhouse 100. As can be best seen in FIG. 2, greenhouse 100 includes at least one bottom slot 172 on the outer face 124 of bottom member 120. The bottom slot 172 allows water to drain from greenhouse 100. Additionally, the bottom slot 172 helps to provide ventilation for greenhouse 100. The bottom slot 172 passes completely through the bottom member, from the outer face 124 to the inner face 122 of bottom member 120. As shown here, the bottom slot 172 extends across the outer face 124 of bottom member 120 between first side edge 127 and second side edge 129. However, this is not necessary. For example, the bottom slot 172 could be a hole located on the outer face 124 of bottom member 120 that through bottom member 120 to the inner face 122 of bottom member 120. There is usually more than one bottom slot; three bottom slots are depicted here.

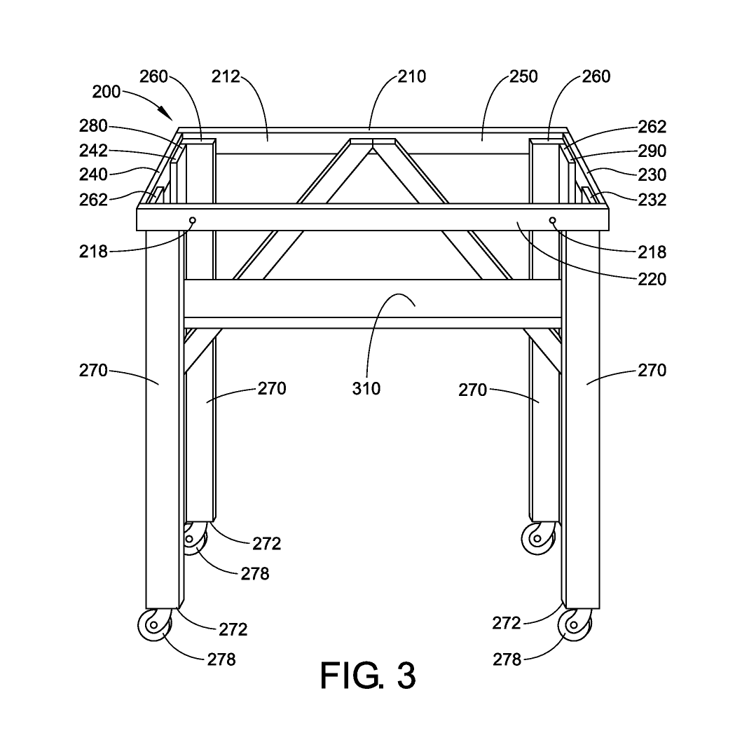

FIG. 3 is a perspective view of a first embodiment of a rolling stand 200. The stand 200 includes a first outer wall 210, a second outer wall 220, a third outer wall 230, a fourth outer wall 240, and at least three legs 270 (four legs are illustrated here).

The first outer wall 210 is located opposite the second outer wall 220. The third outer wall 230 is located opposite the fourth outer wall 240. The first and second outer walls 210, 220 are connected to the third and fourth outer walls 230, 240. In this way, the outer walls 210, 220, 230, 240 form a hollow parallelogram 250. This arrangement can be best seen in FIG. 3, and this arrangement defines a cavity inside the hollow parallelogram 250. A base surface 260 is present in the cavity for supporting the greenhouse. As described further below, the base surface can be provided in one of two ways.

The legs 270 of stand 200 are connected to inner faces 212, 232, 242, of the outer walls 210, 220, 230, 240. The inner face of the second outer wall 220 is not shown. The top faces of the legs 270 can define the base surface 260 in the cavity of the hollow parallelogram 250.

The stand 200 may include at least two inner members 280, 290. The inner members 280, 290 are connected to inner faces of opposing outer walls. Put another way, inner members 280, 290 are located on opposing outer walls. For example, if the first inner member 280 is connected to the inner face 232 of outer wall 230, the second inner member 290 would be connected to the inner face 242 of outer wall 240. Similarly, if the first inner member 280 is connected to the inner face 212 of outer wall 210, the second inner member 290 would be connected to the inner face (not shown) of outer wall 220. The inner members 280, 290 can also define the base surface 262 in the cavity of the hollow parallelogram 250. Any combination of the legs and the inner members can be used to form the base surface 260.

The outer walls 210, 220, 230, 240 of the stand 200 may include holes 218. The holes 218 help to provide water drainage for the greenhouse 100 when placed on the stand 200. The stand 200 includes wheels 278. The wheels 278 are located at the lower end 272 of each leg 270. The wheels 278 allow the stand 200 to be quickly and easily transported. The stand 200 also includes at least one central shelf 310. The central shelf 310 is useful for holding various items. The central shelf 310 is located between the legs 270 of the stand 200 and extends transversely below the cavity of the stand 200.

FIG. 4 is a perspective view of a growing assembly 10. The growing assembly 10 comprises a greenhouse 100 and a stand 200. The bottom member 120 of the greenhouse 100 rests on the base surface 260 (not visible) when the greenhouse 100 is placed within the cavity of the hollow parallelogram 250 defined by the outer walls 210, 220, 230, 240 of stand 200. The hollow parallelogram 250 can be considered a rim that keeps the greenhouse in place

The lid member 110 of the greenhouse 100 is shown in FIG. 4 in an opened position. When the lid member 110 is in the opened position, access is provided to the interior of the greenhouse 100.

Also visible in FIG. 4 is another aspect of the rolling stand 200. The stand 200 further includes at least one wing shelf 320. The wing shelf 320 is useful for holding various items. The wing shelf 320 is rotatable between a vertical position and a horizontal position. The wing shelf 320 is shown here in the horizontal position. When the wing shelf 320 is in the horizontal position, the wing shelf 320 extends outwardly away from the cavity of the stand 200. When the wing shelf 320 is in the vertical position, the wing shelf 320 is located below the cavity of the stand 200. The wing shelf can be quickly and easily rotated between the horizontal and vertical positions. When the wing shelf 320 is in the horizontal position as shown in FIG. 4, a brace 330 is provided for supporting the wing shelf 320. The brace 330 is removed when the wing shelf 320 is in the vertical position, and the brace 330 may be conveniently stored in a pocket in one of the legs 270 of the stand 200. Usually, two wing shelves are present (one on each side of the stand).

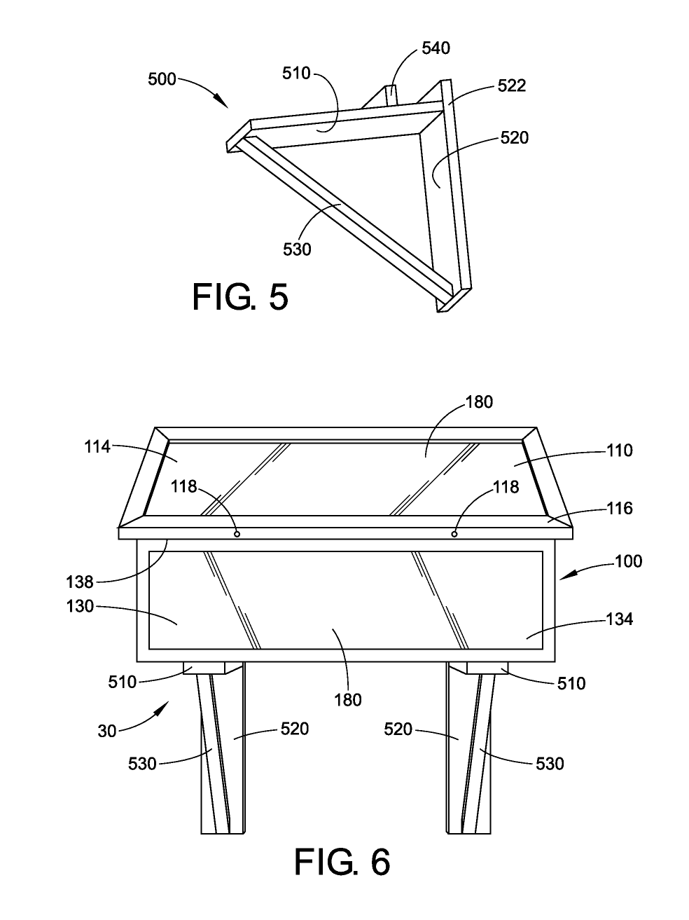

FIG. 5 is a perspective view of a bracket 500. The bracket 500 has at least three planar members 510, 520, 530. The planar members 510, 520, 530 are connected to one another such that the bracket 500 defines a substantially triangular cross-section as shown if FIG. 5. Generally, bracket 510 will provide a horizontal surface on which the greenhouse can be placed. A raised member 540 projects upwardly from the planar member, and engages a bottom slot 172 of the greenhouse to hold the greenhouse in place. The planar member 520 may, if desired, included a raised portion 522 which can be useful for fastening the bracket to a vertical surface (i.e. a wall).

FIG. 6 is a perspective view of a growing assembly 30. The growing assembly 30 comprises a greenhouse 100 and two of the brackets 500 illustrated in FIG. 5.

As best seen in FIG. 6, the bracket 500 acts as a support for the greenhouse 100 when the greenhouse 100 is placed on the bracket 500. In particular, the raised member 540 of the bracket 500 engages a bottom slot 172 on the outer face 124 of the bottom member 120 of the greenhouse 100 when the greenhouse 100 is placed on the bracket 500.

The lid member 110 of the greenhouse 100 is shown in FIG. 6 in a closed position. When the lid member 110 is in the closed position, access to the interior of the greenhouse 100 is prevented.

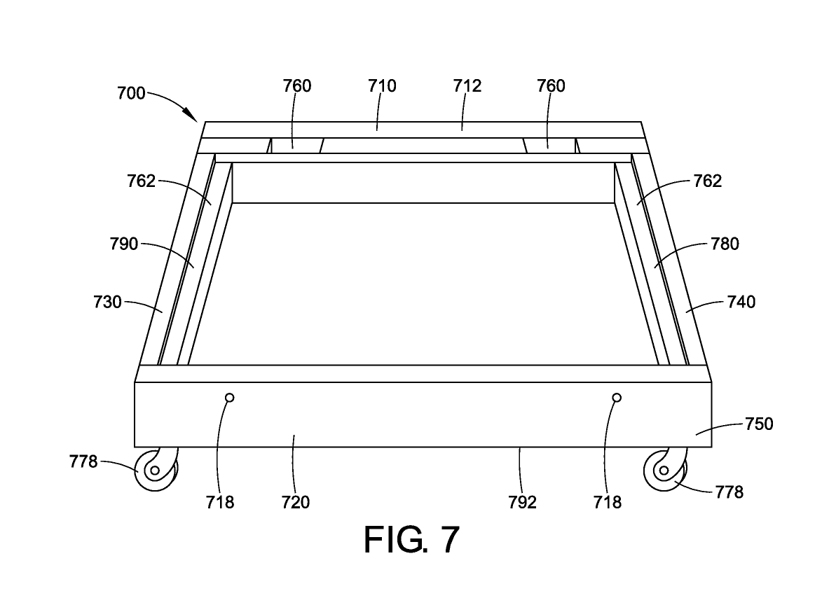

FIG. 7 is a perspective view of a second embodiment of a rolling stand 700. The stand 700 includes a first outer wall 710, a second outer wall 720, a third outer wall 730, a fourth outer wall 740, a first inner member 780, a second inner member 790, and at least three wheels 778 (usually four wheels).

The first outer wall 710 is located opposite the second outer wall 720. The third outer wall 730 is located opposite the fourth outer wall 740. The first and second outer walls 710, 720 are connected to the third and fourth outer walls 730, 740. In this way, the outer walls 710, 720, 730, 740 form a hollow parallelogram 750. This arrangement can be best seen in FIG. 7, and this arrangement defines a cavity inside the hollow parallelogram 750.

The stand 700 includes wheels 778. The wheels 778 are located along a bottom edge 792 of the hollow parallelogram 750 of stand 700. The wheels 778 allow the stand 700 to be quickly and easily transported. Compared to FIG. 3, this embodiment does not have legs 270, and the wheels are mounted directly to the parallelogram 750.

Inner members 780, 790 are connected to inner faces of opposing outer walls. Put another way, inner members 780, 790 are located on opposing outer walls. For example, if the first inner member 780 is connected to outer wall 730, the second inner member 790 would be connected to outer wall 740. Similarly, if the first inner member 780 is connected to outer wall 710, the second inner member 790 would be connected to outer wall 720. The inner members 780, 790 define a base surface 762 in the cavity of the hollow parallelogram 750. The base surface 762 serves as a surface for supporting another item thereon.

One or more of the outer walls 710, 720, 730, 740 of the stand 700 may include holes 718. The holes 718 help to provide water drainage for the greenhouse 100.

The first outer wall 710 includes at least one base slot 760 in a top edge 712 of the first outer wall 710. As explained further below, extensions can be added to the stand and engage the base slot. Usually, a plurality of base slots are present on the top edge of the same outer wall.

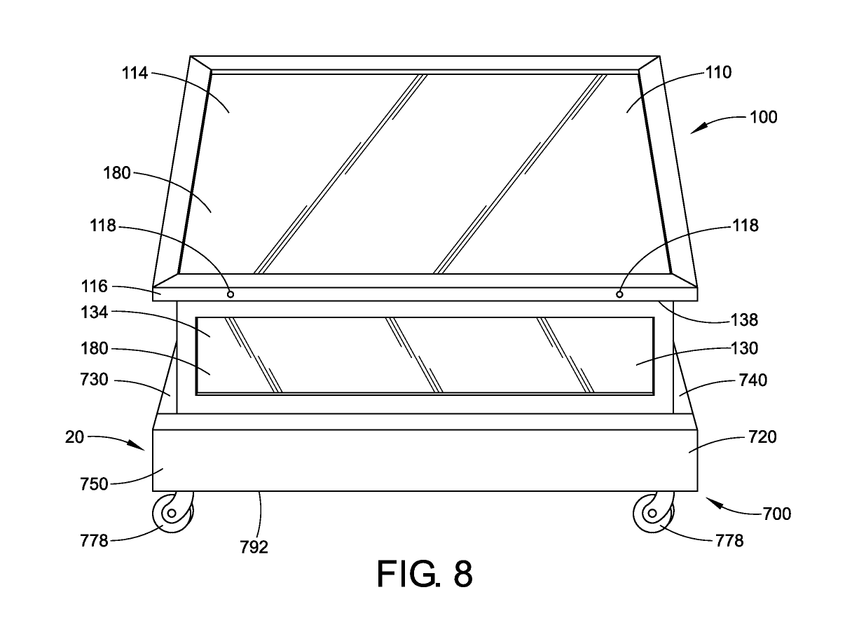

FIG. 8 is a perspective view of a growing assembly 20. The growing assembly 20 comprises a greenhouse 100 and a stand 700 as shown in FIG. 7. The base surface 762 (not visible) supports the greenhouse 100 when the greenhouse is placed within the cavity of the stand 700. The hollow parallelogram 750 can be considered a rim that keeps the greenhouse in place.

The lid member 110 of the greenhouse 100 is shown in FIG. 8 in a closed position. When the lid member 110 is in the closed position, access to the interior of the greenhouse 100 is prevented.

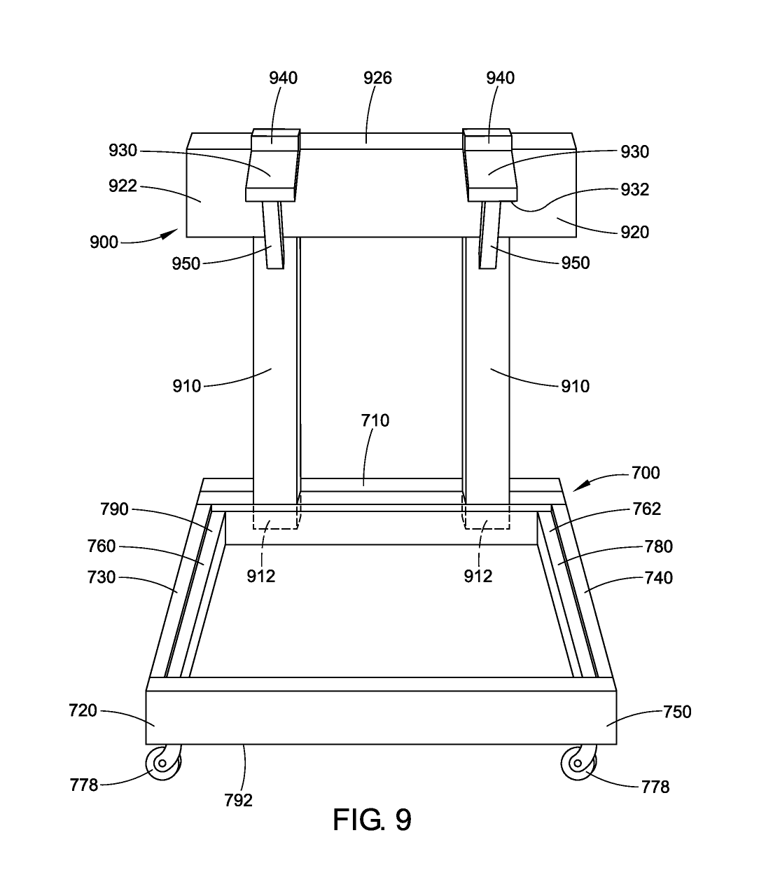

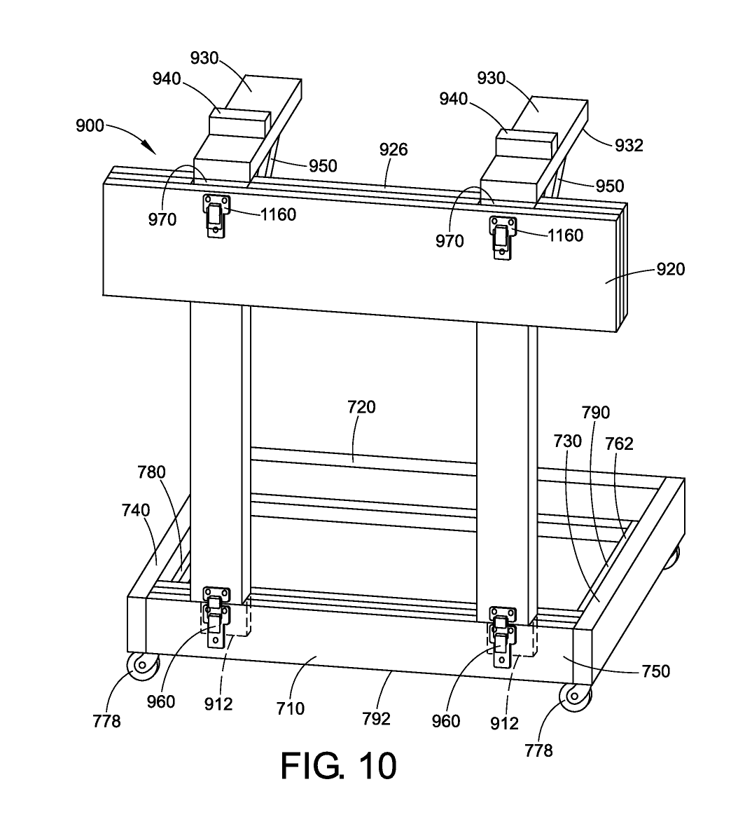

FIG. 9 is a front perspective view of the rolling stand 700 and a first extension 900. FIG. 10 is a rear perspective view of FIG. 9.

The first extension 900 includes at least one primary leg 910, a main portion 920, at least one attachment slot 970, and at least one primary support member 930. The first extension 900 acts as an elevated support upon which the greenhouse 100 may be placed. This can be useful when multiple greenhouses are used, for example by placing a first greenhouse 100 on the stand 700 and a second greenhouse on the first extension 900.

The first extension depicted here has two primary legs 910. Each primary leg 910 of the first extension 900 extends downwardly away from the main portion 920. The main portion 920 is oriented in a horizontal direction. A lower end 912 of each primary leg 910 engages a base slot 760 of the stand 700 (see dashed lines). Put another way, the first extension includes a male connector 912 and the stand 700 includes a complementary female connector 760. The primary leg 910 is preferably sized to fit into the base slot 760 of the stand 700 so that the primary leg 910 may be quickly and easily fit into the base slot 760 of the stand 700. The attachment slot 970 of the first extension 900 is in a top edge 926 of the main portion 920 of the first extension 900, i.e. opposite the primary leg 910.

The primary support member 930 extends away from the main portion 920 over the cavity of the stand 700. The primary support member 930 includes a primary raised member 940. The primary raised member 940 projects upwardly from the primary support member 930. The primary raised member 940 of the first extension 900 engages a bottom slot 172 on the outer face 124 of the bottom member 120 of the greenhouse 100 when the greenhouse 100 is placed on the first extension 900.

FIG. 10 is a perspective view of the back of stand 700 and first extension 900.

As can be best seen in FIG. 10, the primary support member 930 includes a primary prop 950. The primary prop 950 serves to buttress the primary support member 930. The primary prop 950 is connected to a bottom face 932 of the primary support member 930 and an inner face 922 of the first extension, which includes the main portion 920 and the primary leg 910.

As shown in FIG. 10, at least one primary latch 960 may be provided. The primary latch 960 serves to secure the first extension 900 to the stand 700 when the first extension 900 is placed in the stand 700. The primary latch 960 may be any sufficient means for securely latching the first extension 900 to the stand 700, such as a clasp, a case catch, an overcenter latch, or the like. One part of the primary latch is connected to the stand 700, and the other part of the primary latch is connected to the first extension 900.

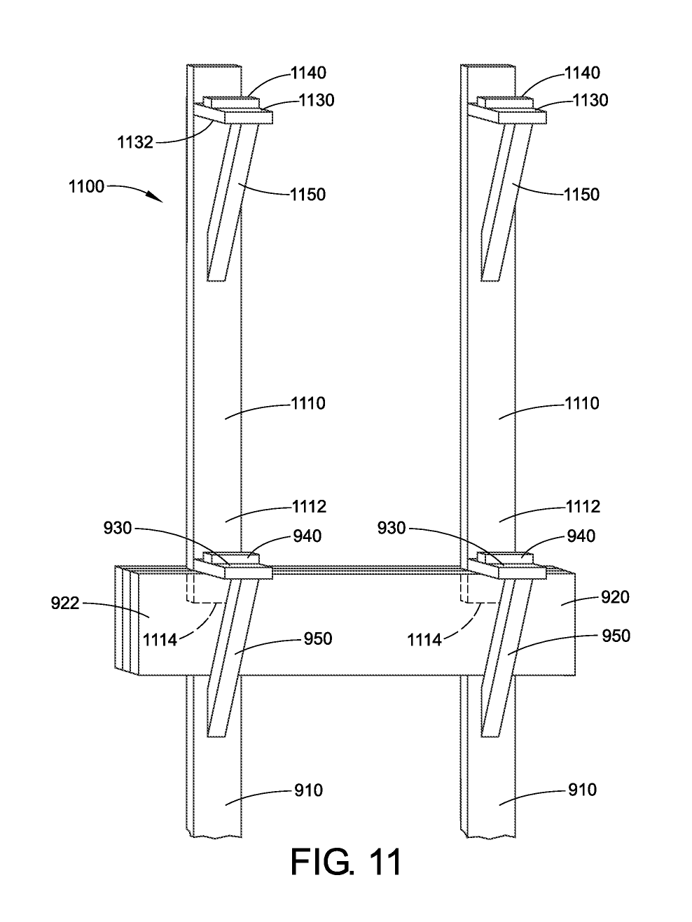

FIG. 11 is a perspective view of a second extension 1100. In FIG. 11, the primary leg 910 of the first extension 900 is shown but is cut off before the main portion 920 of the first extension 900 in order to better show the features of the second extension 1100. The second extension 1100 includes at least one secondary leg 1110 and at least one secondary support member 1130. The second extension 1100 acts as a support upon which the greenhouse 100 may be placed, as an alternative to the stand 700 or the first extension 900. Multiple hotbeds may be provided, in which case a greenhouse 100 may be placed on the stand 700, a greenhouse may be placed on the first extension 900, and a greenhouse may be placed on the second extension 1100.

A lower end 1112 of the secondary leg 1110 of the second extension 1100 engages the attachment slot 970 of the first extension 900. The lower end 1112 of the secondary leg 1110 is depicted in FIG. 11 as a dashed line to indicate that the lower end 1112 of the secondary leg 1110 extends into the attachment slot 970 of the first extension 900. The secondary leg 1110 is sized to fit into the attachment slot 970 of the first extension 900 so that the secondary leg 1100 may be quickly and easily fit into the attachment slot 970 of the first extension 900.

The secondary support member 1130 extends away from the secondary leg 1110 over the cavity of the stand 700. The secondary support member includes a secondary raised member 1140. The secondary raised member 1140 of the second extension 1100 engages a bottom slot 172 on the outer face 124 of the bottom member 120 of the greenhouse 100 when the greenhouse 100 is placed on the second extension 1100.

The secondary support member 1130 includes a prop 1150. The prop 1150 serves to buttress the secondary support member 1130. The prop 1150 is connected to a bottom face 1132 of the secondary support member 1130 and an inner face 1114 of the secondary leg 1110.

Turning back to FIG. 10, at least one secondary latch 1160 may be provided. The secondary latch 1160 serves to secure the second extension 1100 to the first extension 900 when the second extension 1100 is placed in the first extension 900. The secondary latch 1160 may be any sufficient means for securely latching the second extension 1100 to the first extension 900, such as a clasp, a case catch, an overcenter latch, or the like. One part of the secondary latch is connected to the second extension 1100, and the other part of the secondary latch is connected to the first extension 900.

The present disclosure has been described with reference to the exemplary embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A growing assembly comprising:
a greenhouse having:
a lid member;
a bottom member;
a front wall connected to a front edge of the bottom member at a lower edge of the front wall;
a rear wall opposite the front wall, wherein the rear wall is connected to a rear edge of the bottom member at a lower edge of the rear wall and connected to the lid member by at least one hinge, wherein the wings of the at least one hinge are connected to a top edge of the rear wall and the inner face of the lid member; and
a first sidewall and a second sidewall, wherein a bottom edge of the first sidewall is connected to a first side edge of the bottom member and a bottom edge of the second sidewall is connected to a second side edge of the bottom member; and
a stand having
opposing first and second outer walls;
opposing third and fourth outer walls;
wherein the first and second outer walls are connected to the third and fourth outer walls so as to form a hollow parallelogram defining a cavity, the cavity having a base surface therein; and
at least three legs, wherein the legs are connected to the inner faces of the outer walls;
wherein the bottom member of the greenhouse rests on the base surface when the greenhouse is placed within the stand.

2. The growing assembly of claim 1, wherein top faces of the legs define the base surface in the cavity.

3. The growing assembly of claim 1, wherein the stand further comprises at least two inner members connected to inner faces of the first and second outer walls, wherein the at least two inner members define the base surface in the cavity.

4. The growing assembly of claim 3, wherein the at least two inner members and a top face of at least one of the legs define the base surface in the cavity.

5. The growing assembly of claim 1, wherein the greenhouse further comprises at least one bottom slot on the outer face of the bottom member.

6. The growing assembly of claim 1, wherein the lid member, the bottom member, the front wall, the rear wall, and the sidewalls further comprise transparent panel portions.

7. The growing assembly of claim 1, wherein a top edge of one of the sidewalls has a groove sized to hold a pin therein, the pin sized to hold the lid member in an opened position by placing the pin between a top edge of the front wall and the inner face of the lid member.

8. The growing assembly of claim 1, wherein at least one of the lid member or an outer wall of the stand has a hole for ventilation.

9. The growing assembly of claim 1, wherein each leg of the stand further comprises a wheel at a lower end of the leg.

10. The growing assembly of claim 1, wherein the stand further comprises at least one central shelf located between the legs and extending transversely below the cavity.

11. The growing assembly of claim 1, wherein the stand further comprises at least one wing shelf rotatable between a vertical position and a horizontal position, wherein the wing shelf is located below the cavity when in the vertical position, and wherein the wing shelf extends outwardly away from the cavity when in the horizontal position.

12. The growing assembly of claim 11, further comprising a brace for supporting the wing shelf, wherein one leg of the stand includes a pocket in which the brace can be stored.

13. A growing assembly comprising:
a greenhouse having:
a lid member;
a bottom member;
a front wall connected to a front edge of the bottom member at a lower edge of the front wall;
a rear wall opposite the front wall, wherein the rear wall is connected to a rear edge of the bottom member at a lower edge of the rear wall and connected to the lid member by at least one hinge, wherein the wings of the at least one hinge are connected to a top edge of the rear wall and the inner face of the lid member; and
a first side wall and a second sidewall, wherein a bottom edge of the first sidewall is connected to a first side edge of the bottom member and a bottom edge of the second sidewall is connected to a second side edge of the bottom member; and
a stand having:
opposing first and second outer walls, wherein a top edge of the first outer wall has at least one base slot;
opposing third and fourth outer walls;
wherein the first and second outer walls are connected to the third and fourth outer walls so as to form a hollow parallelogram defining a cavity therein;
at least two inner members, wherein the first inner member is connected to one of the outer walls and the second inner member is connected to the opposing outer wall, wherein the at least two inner members define a base surface in the cavity, wherein the bottom member of the greenhouse rests on the base surface when the greenhouse is placed within the stand; and
at least three wheels along a bottom edge of the hollow parallelogram.

14. The growing assembly of claim 13, further comprising a first extension having:
at least one primary leg extending downwardly from a main portion, a lower end of the primary leg engaging the at least one base slot of the stand;
at least one attachment slot in a top edge of the main portion; and
at least one primary support member extending away from the main portion over the cavity of the stand, wherein the primary support member has a primary raised member projecting upwardly from the primary support member, wherein the primary raised member can engage a bottom slot on the outer face of the bottom member of the greenhouse when the greenhouse is placed on the first extension.

15. The growing assembly of claim 14, wherein the primary support member further comprises a primary prop connected to a bottom face of the first support member and an inner face of the first extension for buttressing the first support member.

16. The growing assembly of claim 14, further comprising at least one primary latch for securing the first extension to the stand.

17. The growing assembly of claim 14, further comprising a second extension, the second extension having:
at least one secondary leg, a lower end of the secondary leg engaging the at least one attachment slot of the first extension;
at least one secondary support member extending away from the at least one secondary leg over the cavity of the stand, wherein the secondary support member has a secondary raised member projecting upwardly from the secondary support member, wherein the secondary raised member can engage a bottom slot on the outer face of the bottom member of the greenhouse when the greenhouse is placed on the second extension.

18. The growing assembly of claim 17, wherein the secondary support member further comprises a secondary prop connected to a bottom face of the secondary support member and an inner face of the at least one secondary leg for buttressing the secondary support member.

19. The growing assembly of claim 17, further comprising at least one secondary latch for securing the second extension to the first extension.

20. A growing assembly comprising:
a greenhouse having
a lid member;
a bottom member;
a front wall connected to a front edge of the bottom member at a lower edge of the front wall;
a rear wall opposite the front wall, wherein the rear wall is connected to a rear edge of the bottom member at a lower edge of the rear wall and connected to the lid member by at least one hinge, wherein the wings of the at least one hinge are connected to a top edge of the rear wall and the inner face of the lid member; and
a first sidewall and a second sidewall, wherein a bottom edge of the first sidewall is connected to a first side edge of the bottom member and a bottom edge of the second sidewall is connected to a second side edge of the bottom member; and
at least one bracket for supporting the greenhouse, the bracket having:
at least three planar members, wherein the planar members are connected such that the bracket defines a substantially triangular cross-section;
wherein at least one of the planar members has a raised member projecting upwardly from the planar member, wherein the raised member can engage a bottom slot on the outer face of the bottom member of the greenhouse when the greenhouse is placed on the bracket.
